(19) United States
(12) Patent Application Publication
(10) Pub. No.: US 2023/0051313 A1
(43) Pub. Date: Feb. 16, 2023

(54) METHOD AND SYSTEM FOR ANALYZING SPECIFICATION PARAMETER OF ELECTRONIC COMPONENT, COMPUTER PROGRAM PRODUCT WITH STORED PROGRAM, AND COMPUTER READABLE MEDIUM WITH STORED PROGRAM

(71) Applicant: FOOTPRINTKU INC., Kaohsiung City (TW)

(72) Inventors: YAN-JHIH WANG, Kaohsiung City (TW); KUN-YOU LIN, Kaohsiung City (TW); JUN-QIANG WEI, Kaohsiung City (TW); WEI-CHI CHENG, Kaohsiung City (TW); YI-TING CHEN, Kaohsiung City (TW)

(21) Appl. No.: 17/399,353

(22) Filed: Aug. 11, 2021

(51) Int. Cl. G06T 7/00; G06K 9/62; G06F 30/31; G06N 5/02; G06N 5/04

(52) U.S. Cl. CPC G06T 7/001; G06K 9/6257; G06F 30/31; G06N 5/02; G06N 5/04; G06T 2207/20076; G06T 2207/30148

(57) ABSTRACT

A method for analyzing a specification parameter of an electronic component includes inputting a package type and at least one engineering drawing image of an electronic component; acquiring a probability value that in each view of the different viewing directions each of the plurality of specification parameter of the electronic component is labeled; taking the view of each of the plurality of specification parameters in the view direction with a highest probability value as a recommended view; performing a box selection on the plurality of specification parameters for at least one engineering drawing image with the same viewing direction as that of the recommended view by an object detection model; and identifying box-selected specification parameters to acquire a size value of identified specification parameters from the at least one engineering drawing image, and converting the size value into a corresponding editable text for output.

### BACKGROUND OF THE INVENTION

### 1. Field of the Invention

The present invention generally relates to an analysis method and, more particularly, to a method and system for acquiring a specification parameter of an electronic component by analyzing an engineering drawing image of the electronic component, a computer program product with a stored program, and a computer readable medium with a stored program.

### 2. Description of the Related Art

In the product datasheets of semiconductor related electronic components, numerous data of the electronic components, such as power supply voltage, current, power consumption, resources, package size, pin distribution and other basic contents, are recorded for designers such as layout engineers and hardware engineers to consult. However, these people check the product datasheet page by page to look for the desired data of the electronic components and manually input the related data of the electronic components into the computer system, thereby causing the problems of waste of manpower and time, poor consulting efficiency, high error rate of input data and the like.

In light of this, it is necessary to improve the conventional method for analyzing a specification parameter of an electronic component.

### SUMMARY OF THE INVENTION

It is therefore an objective of the present invention to provide a method for analyzing a specification parameter of an electronic component, which can acquire the specification parameters of the electronic component by analyzing an engineering drawing image of the electronic component.

It is another objective of the present invention to provide a method for analyzing a specification parameter of an electronic component, which can determine whether a size value of the identified specification parameter falls within a reasonable range and correct the size value when the size value falls outside the reasonable range.

It is yet another objective of the present invention to provide a system for analyzing a specification parameter of an electronic component, a computer program product with a stored program, and a computer readable medium with a stored program, for executing the above method.

As used herein, the term “one”, “a” or “an” for describing the number of the elements and members of the present invention is used for convenience, provides the general meaning of the scope of the present invention, and should be interpreted to include one or at least one. Furthermore, unless explicitly indicated otherwise, the concept of a single component also includes the case of plural components.

It may be understood by one of ordinary skill in the art that the “expert system” used herein refers to a computer intelligent program system with special knowledge and experience. Generally speaking, the expert system includes a knowledge base and an inference engine.

It may be understood by one of ordinary skill in the art that the “computer” used herein refers to a variety of data processing apparatuses having a specific function and implemented with hardware or hardware and software, such as a server, a virtual machine (e.g. Amazon and Azure), a desktop computer, a laptop, a tablet or a smartphone.

It may be understood by one of ordinary skill in the art that the “computer program product” used herein refers to an object which is stored with a computer readable program and is not limited by an external form thereof.

It may be understood by one of ordinary skill in the art that the “computer readable medium” used herein refers to a carrier on which software is stored, and the software may be accessed by a computer and typically includes an optical disc, a hard disk, a Universal Serial Bus (USB) flash drive, various memory cards, and cloud or virtual memory spaces.

It may be understood by one of ordinary skill in the art that the “processor unit” used herein refers to any electronic chip with data storage, operation and signal generation functions, or electronic equipment having the electronic chip. For example, the electronic chip may be a central processing unit (CPU), a micro control unit (MCU), a digital signal processor (DSP), a field programmable gate array (FPGA) or a system on chip (SoC). The electronic equipment may be a programmable logic controller (PLC) or an Arduino UNO. The processor unit may be selected by those of ordinary skill in the art according to operation efficiency, price, volume limitation or required function, etc.

It may be understood by one of ordinary skill in the art that the “database” used herein refers to a group of related electronic data collected and stored in a hard disk, a memory or a combination thereof. Electronic data may be processed by virtue of grammatical functions provided by a database management system (DBSMS), such as add, read, search, update, delete, etc. The database management system may management electronic data by different data structure models, such as a relational model, a hierarchical model, a network model or an object-oriented model. The present invention is described below by taking the relational database management system as an example, but is not limited in this regard.

A method for analyzing the specification parameter of the electronic component according to the present invention includes inputting a package type and at least one engineering drawing image of an electronic component under test, with the at least one engineering drawing image being a view of at least one viewing direction of the electronic component under test; querying data meeting the package type of the electronic component under test from a knowledge base of an expert system to acquire a plurality of specification parameters of the electronic component under test from the knowledge base and a probability value that in each view of the different viewing directions each of the plurality of specification parameters is labeled, and taking the view of each of the plurality of specification parameters in the view direction with a highest probability value as a recommended view; and according to the recommended view of each of the plurality of specification parameters of the electronic component under test, performing a box selection on the plurality of specification parameters for at least one engineering drawing image with the same viewing direction as that of the recommended view by an object detection model, identifying box-selected specification parameters to acquire a size value of identified specification parameters from the at least one engineering drawing image, and converting the size value into a corresponding editable text for output.

The present invention discloses a computer program product with the stored program and a computer readable medium with the stored program, which are capable of performing the above method after a computer system loads and executes the stored program. Therefore, the above method may be used, interchanged or executed conveniently, such that the method for analyzing the specification parameter of the electronic component is widely applied to other application software.

A system for analyzing a specification parameter of an electronic component includes an input unit, configured to input a package type and at least one engineering drawing image of an electronic component under test, with the at least one engineering drawing image being a view of at least one viewing direction of the electronic component under test; an expert system, provided with a knowledge base, with the knowledge base being configured to store package types of a plurality of electronic components, a plurality of specification parameters, a reasonable range of each of the plurality of specification parameters, and a probability value that in each view of the different viewing directions each of the plurality of specification parameters is labeled; an object detection model, configured to acquire a size value of the plurality of specification parameters of the electronic component under test from at least one engineering drawing image of the electronic component under test; and a processor unit, electrically connected to the input unit, the expert system and the object detection model, with the processor unit querying data meeting the package type of the electronic component under test from the knowledge base to acquire a plurality of specification parameters of the electronic component under test and the probability value that in each view of the different viewing directions each of the plurality of specification parameters is labeled, the processor unit taking the view of each of the plurality of specification parameters in the view direction with a highest probability value as a recommended view, and the processor unit controlling the object detection model to perform a box selection on the plurality of specification parameters for at least one engineering drawing image with the same viewing direction as that of the recommended view, identifying box-selected specification parameters to acquire a size value of identified specification parameters from the at least one engineering drawing image and convert the size value into a corresponding editable text for output.

Accordingly, the method and system for analyzing the specification parameter of the electronic component, the computer program product with the stored program and the computer readable medium with the stored program according to the present invention can record package types and the plurality of specification parameters of the plurality of electronic components and the probability value that in each view of the different viewing directions each of the plurality of specification parameters is labeled by the expert system The data meeting the package type of an electronic component under test is queried by the expert system to acquire the recommended view of each of the plurality of specification parameters of the electronic component under test, and the processor unit controls the object detection model to identify at least one engineering drawing image of each of the plurality of specification parameters with the same viewing direction as that of the recommended view to acquire a size value of each of the plurality of specification parameters. Thus, the present invention has the effects of reducing manpower and time cost, improving consulting efficiency and reducing data error rate.

In an example, the at least one engineering drawing image includes at least one of a top view, a bottom view, a side view, a cross-sectional view and a land pattern view. Thus, the method and system for analyzing the specification parameter of the electronic component have the effect of expanding the application range.

In an example, the method further includes comparing the size value of each of the plurality of specification parameters of the electronic component under test with a corresponding reasonable range stored in the knowledge base by an inference engine of an expert system, and recording the size value of the plurality of specification parameters corresponding to the electronic component under test into a database if the size value of the plurality of specification parameters falls within the corresponding reasonable range. Thus, the method for analyzing the specification parameter of the electronic component has the effects of knowing whether the size value identified by the object detection model is wrong by virtue of the reasonable range of the plurality of specification parameters and recording the correct size value of the plurality of specification parameters.

In an example, if the size value of the plurality of specification parameters does not fall within the corresponding reasonable range, the size value of the plurality of specification parameters is corrected. Thus, the method for analyzing the specification parameter of the electronic component has the effect of increasing the overall analysis accuracy rate.

In an example, if the size value of the plurality of specification parameters does not fall within the reasonable range of the corresponding value, the object detection model is retrained to reacquire a size value of the plurality of specification parameters. Thus, the method for analyzing the specification parameter of the electronic component has the effect of reducing manpower and increasing the overall analysis accuracy rate.

In an example, the processor unit controls an inference engine of the expert system to compare the size value of each of the plurality of specification parameters of the electronic component under test with a corresponding reasonable range stored in the knowledge base, and if the size value of the plurality of specification parameters falls within the corresponding reasonable range, the processor unit records the size value of the plurality of specification parameters corresponding to the electronic component under test into a database. Thus, the system for analyzing the specification parameter of the electronic component according to the present invention has the effects of knowing whether the size value identified by the object detection model is wrong by virtue of the reasonable range of the plurality of specification parameters and recording the correct size value of the plurality of specification parameters.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 is a flowchart of a method for analyzing a specification parameter of an electronic component according to the present invention.

FIG. 2 is a block diagram of a system for analyzing a specification parameter of an electronic component according to the present invention.

In the various figures of the drawings, the same numerals designate the same or similar parts. Furthermore, when the terms “front”, “rear”, “left”, “right”, “upper (top)”, “lower (bottom)”, “inner”, “outer” and “side” and similar terms are used hereinafter, it should be understood that these terms have reference only to the structure shown in the drawings as it would appear to a person viewing the drawings, and are utilized only to facilitate describing the invention.

### DETAILED DESCRIPTION OF THE INVENTION

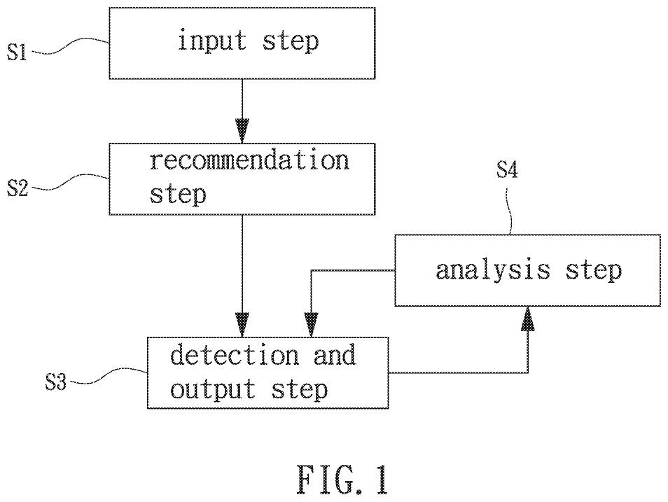

Referring to FIG. 1, which is a preferred embodiment of a method for analyzing a specification parameter of an electronic component according to the present invention, the method includes an input step S1, a recommendation step S2 and a detection and output step S3.

The input step S1 includes inputting a package type and at least one engineering drawing image of an electronic component under test. The at least one engineering drawing image is a view of the electronic component under test in at least one viewing direction. In this embodiment, the at least one engineering drawing image includes at least one of a top view, a bottom view, a side view, a cross-sectional view and a land pattern view. Preferably, the at least one engineering drawing image includes one of a top view, a front view, a left view and a right view. The front view, the left view and the right view are collectively referred to as the side view.

In the recommendation step S2, data meeting the package type of the electronic component under test is queried from a knowledge base of an expert system to acquire a probability value that in each view of the different viewing directions each of a plurality of specification parameters is labeled. The view of each of the plurality of specification parameters in the view direction with the highest probability value is taken as a recommended view. For example, the package type, the plurality of specification parameters of the electronic component and the probability value that in each view of the different viewing directions each of the plurality of specification parameters is labeled stored in the knowledge base may be shown as Table 1. When the specification parameter of the electronic component under test is a component length, the recommended view of the component length is the top view of the electronic component under test.

TABLE 1
relevance table of the specification
parameters of the electronic component
Package type: plastic quad flat package (QFP)

| | Viewing direction | | | |
|---|---|---|---|---|
| | | | | Land |
| | Top | Bottom | Side | pattern |
| Specification parameter | view | view | view | view |
| Component length | 89.39% | 32.61% | 0% | 0% |
| Component width | 91.92% | 28.08% | 0% | 0% |
| Component height | 0% | 0% | 77.19% | 0% |
| Package length | 90.91% | 9.09% | 0% | 0% |
| Package width | 90.91% | 9.09% | 0% | 0% |
| Package thickness/height | 0% | 0% | 95.47% | 0% |
| Height beneath package | 0% | 0% | 77.43% | 0% |
| Distance between opposite | 0% | 87.32% | 12.38% | 0% |
| pins along horizontal axis | | | | |
| Distance between adjacent | 0% | 60.85% | 73.62% | 0% |
| pins along horizontal axis | | | | |
| Distance between opposite | 0% | 89.23% | 8.69% | 0% |
| pins along longitudinal axis | | | | |
| Distance between adjacent | 0% | 50.47% | 81.38% | 0% |
| pins along longitudinal axis | | | | |
| Distance between opposite | 0% | 0% | 0% | 100% |
| pins along horizontal axis | | | | |
| in land pattern | | | | |
| Distance between adjacent | 0% | 0% | 0% | 100% |
| pins along horizontal axis | | | | |
| in land pattern | | | | |
| Distance between opposite | 0% | 0% | 0% | 100% |
| pins along longitudinal axis | | | | |
| in land pattern | | | | |
| Distance between adjacent | 0% | 0% | 0% | 100% |
| pins along longitudinal axis | | | | |
| in land pattern | | | | |

In the detection and output step S3, according to the recommended view of each of the plurality of specification parameters of the electronic component under test, a box selection is performed by an object detection model on the plurality of specification parameters for at least one engineering drawing image with the same viewing direction as that of the recommended view. The box-selected specification parameters are identified to acquire a size value of the identified specification parameters from the at least one engineering drawing image, and the size value is converted into a corresponding editable text for output. Specifically, the object detection model is a text detection model. In this embodiment, the text detection model may be, for example, an efficient and accurate scene text (EAST) target detection network, but the present invention is not limited in this regard. When a basic model of the object detection model is trained for the first time, an image for training may include a top view image, a bottom view image, a side view image, a cross-sectional view image and a land pattern view of different package types of electronic components under test. It is noted that images for training of different package types may not have the land pattern view, which may be understood by one of ordinary skill in the art. The object detection model may perform feature extraction on the engineering drawing image to acquire a feature vector from the engineering drawing image and generate a plurality of specification parameter areas in the engineering drawing image. The object detection model identifies the text in each of the plurality of specification parameters area to acquire a size value of each of the plurality of specification parameters of the electronic component under test.

In addition, in another embodiment of the present invention, a box selection may be performed on the plurality of specification parameters for at least one engineering drawing image by the object detection model. The box-selected specification parameters are identified to acquire a size value of the identified specification parameters from the at least one engineering drawing image. According to the viewing direction of the at least one engineering drawing image and the probability value that in each view of the different viewing directions each of the plurality of specification parameters is labeled, the size value of each of the plurality of specification parameters with the highest probability value identified in the engineering drawing image is converted into corresponding edible text for output.

The method for analyzing the specification parameter of the electronic component according to the present invention may further include an analysis step S4. In the analysis step S4, the size value of each of the plurality of specification parameters of the electronic component under test is compared with the corresponding reasonable range stored in the knowledge base by an inference engine of the expert system. If the size value of the plurality of specification parameter falls within the corresponding reasonable range, the size value of the plurality of specification parameter corresponding to the electronic component under test is recorded into a database for subsequent use by a designer. If the size value of the plurality of specification parameter does not fall within the corresponding reasonable range, the size value of the plurality of specification parameter may be corrected by a user, or the object detection model is retrained to reacquire a size value of the plurality of specification parameter. One of ordinary skill in the art may understand that the size value which does not fall within the corresponding reasonable range and the engineering drawing image may be labeled and serve as a training sample to retrain the object detection model.

The above method embodiment of the present invention may further be written into computer programs, such as an electronic component specification parameter analysis program for analyzing the at least one engineering drawing image of the electronic component to acquire a size value of the plurality of specification parameters of the electronic component, with program language such as C++, Java, Python or Julia. The manner of writing the program code may be understood by one of ordinary skill in the art, and may be used to generate a computer program product with a stored program. The computer program product may perform the above method embodiment of the present invention after a computer system loads and executes the stored program.

The computer program product may further be stored on a computer readable medium with the stored program, such as an optical disc, a hard disk, a Universal Serial Bus (USB) flash drive, various memory cards, and cloud or virtual storage spaces. The computer readable medium may perform the above method embodiment of the present invention after a computer system loads and execute the stored program, to serve as a basis that software and hardware of the computer system of the present invention operate collaboratively.

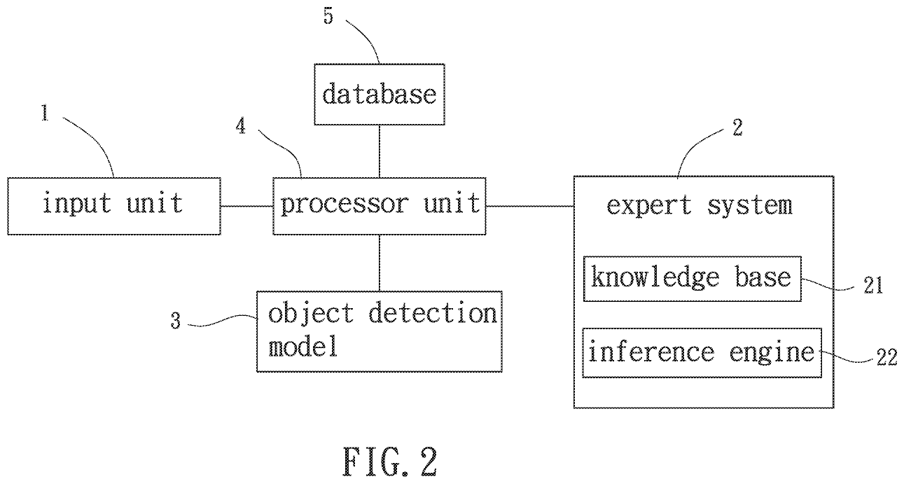

Referring to FIG. 2, which is a preferred embodiment of a system for analyzing a specification parameter of an electronic component according to the present invention, the system includes an input unit 1, an expert system 2, an object detection model 3 and a processor unit 4. The input unit 1, the expert system 2 and the object detection model 3 are electrically connected to the processor unit 4, respectively.

The input unit 1 is configured to input a package type and at least one engineering drawing image of an electronic component under test. The at least one engineering drawing image is a view of the electronic component under test in at least one viewing direction. In this embodiment, the at least one engineering drawing image includes at least one of a top view, a bottom view, a side view, a cross-sectional view and a land pattern view. Preferably, the at least one engineering drawing image includes one of a top view, a front view, a left view and a right view. The front view, the left view and the right view are collectively referred to as the side view. Specifically, the input unit 1 is a device with a function of receiving text and image files.

The expert system 2 is provided with a knowledge base 21 and an inference engine 22. The knowledge base 21 is configured to store package types of a plurality of electronic components, a plurality of specification parameters, the reasonable range of each of the plurality of specification parameters, and a probability value that in each view of the different viewing directions each of the plurality of specification parameters is labeled. The inference engine 22 is configured to evaluate whether the size value of each of the plurality of specification parameters of the electronic component is reasonable according to the reasonable range of each of the plurality of specification parameters stored in the knowledge base 21.

The object detection model 3 is configured to acquire a size value of the plurality of specification parameters of the electronic component under test from at least one engineering drawing image of the electronic component under test. In this embodiment, the object detection model 3 may be an EAST text detection model, but the present invention is not limited in this regard.

The processor unit 4 is electrically connected to the input unit 1, the expert system 2 and the object detection model 3. The processor unit 4 queries data meeting the package type of the electronic component under test from the knowledge base 21 to acquire the probability value that in each view of the different viewing directions each of the plurality of specification parameters of the electronic component under test is labeled. The processor unit 4 takes the view of each of the plurality of specification parameters in the view direction with the highest probability value as a recommended view, and controls the object detection model 3 to perform a box selection on the plurality of specification parameters for at least one engineering drawing image with the same viewing direction as that of the recommended view, identify the box-selected specification parameters to acquire a size value of the identified specification parameters from the at least one engineering drawing image and convert the size value into a corresponding editable text for output.

Preferably, the processor unit 4 may control the inference engine 22 to compare the size value of each of the plurality of specification parameters of the electronic component under test with the corresponding reasonable range stored in the knowledge base 21. If the size value of the plurality of specification parameter falls within the corresponding reasonable range, the processor unit 4 may record the size value of the plurality of specification parameter corresponding to the electronic component under test into a database 5 for sequent use by a designer. If the size value of the plurality of specification parameter does not fall within the corresponding reasonable range, the processor unit 4 may control the object detection model for retraining to reacquire a size value of the plurality of specification parameter.

In summary, the method and system for analyzing the specification parameter of the electronic component, the computer program product with the stored program and the computer readable medium with the stored program according to the present invention can record package types and the plurality of specification parameters of the plurality of electronic components and the probability value that in each view of the different viewing directions each of the plurality of specification parameters is labeled by the expert system. The data meeting the package type of an electronic component under test is queried by the expert system to acquire the recommended view of each of the plurality of specification parameters of the electronic component under test, and the processor unit controls the object detection model to identify at least one engineering drawing image of each of the plurality of specification parameters with the same viewing direction as that of the recommended view to acquire a size value of each of the plurality of specification parameters. Thus, the present invention has the effects of reducing manpower and time cost, improving consulting efficiency and reducing data error rate.

Although the invention has been described in detail with reference to its presently preferable embodiments, it will be understood by one of ordinary skill in the art that various modifications can be made without departing from the spirit and the scope of the invention, as set forth in the appended claims.

What is claimed is:

1. A method for analyzing a specification parameter of an electronic component, comprising:
inputting a package type and at least one engineering drawing image of an electronic component under test, wherein the at least one engineering drawing image is a view of at least one viewing direction of the electronic component under test;
querying data meeting the package type of the electronic component under test from a knowledge base of an expert system to acquire a plurality of specification parameters of the electronic component under test from the knowledge base and a probability value that in each view of the different viewing directions each of the plurality of specification parameters is labeled, and taking the view of each of the plurality of specification parameters in the view direction with a highest probability value as a recommended view; and
according to the recommended view of each of the plurality of specification parameters of the electronic component under test, performing a box selection on the plurality of specification parameters for at least one engineering drawing image with the same viewing direction as that of the recommended view by an object detection model, identifying box-selected specification parameters to acquire a size value of identified specification parameters from the at least one engineering drawing image, and converting the size value into a corresponding editable text for output.

2. The method for analyzing the specification parameter of the electronic component as claimed in claim 1, wherein the at least one engineering drawing image includes at least one of a top view, a bottom view, a side view, a cross-sectional view and a land pattern view.

3. The method for analyzing the specification parameter of the electronic component as claimed in claim 1, further comprising comparing the size value of each of the plurality of specification parameters of the electronic component under test with a corresponding reasonable range stored in the knowledge base by an inference engine of an expert system, and recording the size value of the plurality of specification parameters corresponding to the electronic component under test into a database if the size value of the plurality of specification parameters falls within the corresponding reasonable range.

4. The method for analyzing the specification parameter of the electronic component as claimed in claim 2, further comprising comparing the size value of each of the plurality of specification parameters of the electronic component under test with a corresponding reasonable range stored in the knowledge base by an inference engine of an expert system, and recording the size value of the plurality of specification parameters corresponding to the electronic component under test into a database if the size value of the plurality of specification parameters falls within the corresponding reasonable range.

5. The method for analyzing the specification parameter of the electronic component as claimed in claim 3, wherein if the size value of the plurality of specification parameters does not fall within the corresponding reasonable range, the size value of the plurality of specification parameters is corrected.

6. The method for analyzing the specification parameter of the electronic component as claimed in claim 4, wherein if the size value of the plurality of specification parameters does not fall within the corresponding reasonable range, the size value of the plurality of specification parameters is corrected.

7. The method for analyzing the specification parameter of the electronic component as claimed in claim 3, wherein if the size value of the plurality of specification parameters does not fall within the corresponding reasonable range, the object detection model is retrained to reacquire a size value of the plurality of specification parameters.

8. The method for analyzing the specification parameter of the electronic component as claimed in claim 4, wherein if the size value of the plurality of specification parameters does not fall within the corresponding reasonable range, the object detection model is retrained to reacquire a size value of the plurality of specification parameters.

9. A computer program product with a stored program, which is capable of performing the method for analyzing the specification parameter of the electronic component as claimed in claim 1 after a computer system loads and executes the stored program.

10. A computer readable medium with a stored program, which is capable of performing the method for analyzing the specification parameter of the electronic component as claimed in claim 1 after a computer system loads and executes the stored program.

11. A system for analyzing a specification parameter of an electronic component, comprising:
an input unit, configured to input a package type and at least one engineering drawing image of an electronic component under test, wherein the at least one engineering drawing image is a view of at least one viewing direction of the electronic component under test;
an expert system, provided with a knowledge base, wherein the knowledge base is configured to store package types of a plurality of electronic components, a plurality of specification parameters, a reasonable range of each of the plurality of specification parameters, and a probability value that in each view of the different viewing directions each of the plurality of specification parameters is labeled;
an object detection model, configured to acquire a size value of the plurality of specification parameters of the electronic component under test from at least one engineering drawing image of the electronic component under test; and
a processor unit, electrically connected to the input unit, the expert system and the object detection model, wherein the processor unit queries data meeting the package type of the electronic component under test from the knowledge base to acquire a plurality of specification parameters of the electronic component under test and the probability value that in each view of the different viewing directions each of the plurality of specification parameters is labeled, the processor unit takes the view of each of the plurality of specification parameters in the view direction with a highest probability value as a recommended view, and the processor unit controls the object detection model to perform a box selection on the plurality of specification parameters for at least one engineering drawing image with the same viewing direction as that of the recommended view, identifies box-selected specification parameters to acquire a size value of identified specification parameters from the at least one engineering drawing image and convert the size value into a corresponding editable text for output.

12. The system for analyzing the specification parameter of the electronic component as claimed in claim 11, wherein the at least one engineering drawing image includes at least one of a top view, a bottom view, a side view, a cross-sectional view and a land pattern view.

13. The system for analyzing the specification parameter of the electronic component as claimed in claim 11, wherein the processor unit controls an inference engine of the expert system to compare the size value of each of the plurality of specification parameters of the electronic component under test with a corresponding reasonable range stored in the knowledge base, and if the size value of the plurality of specification parameters falls within the corresponding reasonable range, the processor unit records the size value of the plurality of specification parameters corresponding to the electronic component under test into a database.
